(19) United States
(12) Patent Application Publication
(10) Pub. No.: US 2009/0191251 A1
(43) Pub. Date: Jul. 30, 2009

(54) ANTIMICROBIAL MOLDED ARTICLE, LAMINATE, HEAT INSULATING MATERIAL AND SYNTHETIC LEATHER PRODUCT

(76) Inventors: Fumioki Fukatsu, Chiba (JP); Takaharu Yasue, Chiba (JP)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 12/161,089

(22) PCT Filed: Jan. 12, 2007
(86) PCT No.: PCT/JP2007/050335

§ 371 Date: Jul. 16, 2008

(30) Foreign Application Priority Data
Jan. 16, 2006 (JP) 2006-008082

(51) Int. Cl. A01N 25/08

(52) U.S. Cl. 424/409

(57) ABSTRACT

An antimicrobial molding is prepared by mixing: an antimicrobial composition containing two organic antimicrobial agents selected solely from imidazole organic antimicrobial agent and an inorganic antimicrobial agent; and a curing material such as a thermoplastic resin, light-curing resin, resin cured by two-pack mixing to be formed as a sheet, film, multi-layer-structure and foamed article into a desired shape. Accordingly, a molding that contains the antimicrobial composition exhibiting significantly broad antimicrobial spectrum, negative skin irritation, high-level safety and extremely small influence on human body and environment, and efficiently achieves high antimicrobial effects can be easily obtained.

### TECHNICAL FIELD

The present invention relates to an antimicrobial molding, laminated body, heat insulator and synthetic leather article each containing organic antimicrobial agent and inorganic antimicrobial agent.

### BACKGROUND ART

It is conventionally known that synergetic effect can be obtained by combining two or more agents per one microorganism as an antimicrobial composition for removing or repelling the microorganism such as prokaryote (e.g. bacteria), eucaryote (e.g. mold, yeast) and algae. Specifically, when two or more agents are used, synergetic effects such as broadening of antimicrobial spectrum and decrease in minimum inhibitory concentration (MIC value: ppm) as compared to independently using each of the agents can be attained. In order to use different-type agents, it has been proposed to use an organic antimicrobial agent and an inorganic antimicrobial agent (see, for instance, Patent Document 1).

The one disclosed in the patent document 1 contains: metal component such as silver, copper and zinc; inorganic oxide fine particle consisting of inorganic oxide other than the metal component and exhibiting antimicrobial, antifungal and antialgae effects; and organic antimicrobial, antifungal and antialgae agent containing at least one of thiazole compound and imidazole compound. Considering the influence on dispersibility and surface color tone of a to-be-treated object, the average particle size of the inorganic oxide particle is arranged to be 500 nm or less. The content of the inorganic oxide particle is 0.001 wt % or more for attaining sufficient effects by the parallel use.

[Patent Document 1] JP2004-339102A (Page 4-Page 10)

### DISCLOSURE OF THE INVENTION

### Problems to be Solved by the Invention

Incidentally, since antimicrobial composition is used in a living environment, it is necessary that the antimicrobial composition does not exert harmful effect on human body even when the antimicrobial composition is adhered on a skin while coating the antimicrobial composition on an object or when a user touches a molding coated with or containing the antimicrobial composition. It is also necessary that the antimicrobial composition does not generate harmful substance such as dioxin when a molding coated with or containing the antimicrobial composition is burned.

On the other hand, it is preferable that the agent does not corrode manufacturing facility such as mixing container and molding die while the antimicrobial composition is prepared or antimicrobial-compound-containing molding body is to be molded. In other word, it is preferable that the agent does not necessitate anticorrosive material and/or special equipment for manufacturing facility, which results in construction difficulty and increase in construction cost of the manufacturing facility.

However, the antimicrobial composition that employs combination of organic and inorganic antimicrobial agents as disclosed in the above-mentioned Patent Document 1 do not exert sufficient synergetic effects according to the combination of the agents and the synergetic effects are only applicable to limited microorganisms (i.e. antimicrobial spectrum cannot be significantly broadened). Further, in order to exert sufficient antimicrobial performance while broadening antimicrobial spectrum, MIC value (i.e. additive amount) has to be increased, which is not favorable in terms of efficient antimicrobial action. In addition, the moldability of the molding may be hindered in accordance with the increase in the additive a-mount. Further, the conventional antimicrobial composition contains allergic compound such as 2-(n-octyl)-4-isothiazolin-3-one (abbr. OIT) and 1,2-benzisothiazolin-3-one (abbr. BIT).

An object of the present invention is to provide an antimicrobial molding, laminated body, heat insulator and synthetic leather article that exert antimicrobial effect on a large number of microorganisms, efficiently achieve antimicrobial performance and influence less on human body and environment.

### Means for Solving the Problems

An antimicrobial molding according to an aspect of the invention includes: a curing material; and an antimicrobial composition containing at least two organic antimicrobial agents selected from imidazole organic antimicrobial agents and an inorganic agent.

According to the above aspect of the invention, a molding is prepared by mixing the curing material with the antimicrobial composition including the at least two imidazole organic antimicrobial agents and the inorganic antimicrobial agent in combination.

Accordingly, the molding can exhibit significantly broad antimicrobial spectrum due to the combination solely of imidazole organic antimicrobial agents, which can by no means be expected from a conventional knowledge where chemically different antimicrobial agents are used in order to broaden the antimicrobial spectrum. Further, by inclusion of the antimicrobial composition that shows negative skin irritation, high safety, extremely low influence on human body and the environment and broad antimicrobial spectrum at a low minimum inhibitory concentration (MIC value) on account of synergetic effects, which efficiently achieves high antimicrobial action.

In the present invention, “antimicrobial (antimicrobial effect)” means not only an antimicrobial effect itself for inhibiting growth and development of fungi including fungi and bacteria, but also antifungal effects and anti-algae effects.

Examples of the curing material are: hydraulic-setting synthetic resin such as silicone; hydraulic-setting inorganic material such as cement, mortar and plaster; thermoplastic synthetic resin such as polyethylene, polypropylene, urethane, nylon and vinyl; solvent-dispersing resin such as acryl, urethane, vinyl and polyolefin and solvent-dissolving resin such as acryl, urethane and vinyl, the solvent-dispersing resin and the solvent-dissolving resin being solidified by removing solvent (water, organic solvent and the like); resin that initiates reaction or polymerization to be solidified by two-pack mixing such as epoxy resin; polymerized unsaturated polyester cross-linked by peroxide; and resin such as acrylate monomer and prepolymer that has reactive active group cured by irradiating light beam, ultraviolet, radiation ray or electron beam at a terminal end thereof.

In the above aspect of the invention, resin such as polyvinyl chloride, polyvinyl alcohol copolymer, urethane, and EPDM (ethylene-propylene-diene rubber) may be used as the curing material. The antimicrobial composition according to the invention is added to the curing material and is formed into a sheet-shaped molding, which can be used as a so-called waterproof liner. Specific applications of such waterproof liner is a pool liner installed when a pool or an artificial pond is constructed and a roofing sheet of an architectural construction. Such sheet-shaped molding can be used not only as a single-layer resin sheet, but also as an article in which the sheet-shaped molding is adhered with a fabric (tarpaulin and the like) and a laminated body with further layer of resin sheet (i.e. resin sheet/fabric/resin sheet).

In the above aspect, the antimicrobial composition is preferably contained in an amount between and including 0.01% and 10.0% by mass. When the antimicrobial composition is contained in an amount between and including 0.01% and 10.0% by mass, a molding capable of exhibiting prominent antimicrobial properties can be provided without impairing characteristics such as strength and appearance thereof.

If the content of the antimicrobial composition is less than 0.01 mass %, there is the possibility that sufficient antimicrobial property cannot be obtained. On the other hand, if the content of the antimicrobial composition is more than 10.0 mass %, it is possible that the characteristics of the molding is deteriorated or the workability upon molding process is decreased. Accordingly, the antimicrobial composition is preferably contained in an amount between and including 0.01% and 10.0% by mass. It is especially preferable that the antimicrobial resin sheet contains the antimicrobial composition in an amount between and including 0.05% and 2% by mass.

In the above aspect of the invention, it is preferable that the antimicrobial composition is contained so that the inorganic antimicrobial agent is contained by 0.5% by mass or less of the entire weight of the molding and biocidal activity rate defined by Japan Textile Evaluation Technology Council (general application) satisfies the following conditions:

log(A/C)≧0
where, A: number of fungi on standard fabric immediately after being planted, C; number of living fungi on a treated fabric after 18-hours cultivation, and kind of fungi: staphylococcus aureus and klebsiella pneumoniae.

According to the above arrangement, even when the inorganic antimicrobial agent is contained at 0.3% by mass or less in a molding after the antimicrobial composition is blended into a molding, the biocidal activity rate defined by Japan Textile Evaluation Technology Council satisfies the relationship of log(A/C)≧0, whereby broad antimicrobial spectrum can be exhibited and exerts antimicrobial effect at low MIC value.

In particular, the antimicrobial effects can be efficiently exhibited by controlling the content of the inorganic antimicrobial agent at 0.05% by mass or more, more preferably 0.1% by mass or more. The antimicrobial composition exhibits broad antimicrobial spectrum that cannot be obtained by conventional antimicrobial composition and excellent antimicrobial effect at low MIC value even when the concentration of the antimicrobial composition is low.

In the present invention, the curing material may preferably be a thermoplastic resin.

In the above arrangement, since thermoplastic synthetic resin such as polyethylene, polypropylene, urethane, nylon and vinyl is used as the curing material, the antimicrobial composition can be easily molded into a desired shape by various methods such as extrusion, injection and casting after heating the antimicrobial composition and mixing with the thermoplastic resin, whereby moldings that exhibit high antimicrobial performance can be efficiently obtained.

In the above aspect of the invention, the curing material is preferably a resin material solidified by two-pack mixing In the above aspect, since resin material such as epoxy resin that initiates reaction and polymerization by two-pack mixing is used as the curing material, the antimicrobial composition can be easily molded into a desired shape by various methods such as extrusion, injection and casting after mixing the antimicrobial composition with the two-pack, whereby moldings that exhibit high antimicrobial performance can be efficiently obtained. Polymerized unsaturated polyester that is cross-linked by peroxide, for instance, may alternatively be used as a self-reactive type two-pack resin by initiating reagent.

In the above aspect, the curing material is preferably a resin that is cured by irradiating one of light beam, radiation ray and electron beam. For instance, resin such as acrylate monomer and prepolymer that has reactive active group cured by irradiating light beam, ultraviolet, radiation ray or electron beam at a terminal end thereof can be exemplified.

In the above aspect, since a resin such as acrylate monomer and prepolymer that is cured by irradiation of light beam, ultraviolet, radiation ray or electron and includes reactive active group at the terminal thereof, moldings that exhibit high antimicrobial performance can be efficiently obtained only by mixing the antimicrobial composition with the curing material to mold into a desired shape and, subsequently, curing the mixture by irradiating light beam, ultraviolet, radiation ray or electron beam.

In the above aspect, an average particle size of the antimicrobial composition is preferably controlled to be 1 μm or less.

In the above aspect, since the average particle size of the antimicrobial composition is controlled to be 1 μm or less, dispersibility to the curing material can be improved and the compound can be properly contained with ease where surface smoothness of the molding can be ensured Accordingly, stable and excellent antimicrobial effects can be exerted on the moldings with ease.

In the above aspect, it is preferable that the two organic antimicrobial agents selected from the imidazole organic antimicrobial agents are one having a thiazolyl group on benzimidazole ring and one having a carbamate group on benzimidazole ring.

In the above aspect, since two types of imidazole organic antimicrobial agents, i.e. one having thiazolyl group on benzimidazole ring and one having a carbamate group on benzimidazole ring are used in combination, especially when only two imidazole organic antimicrobial agents are used in combination, antimicrobial effects having no influence on the human body and environment and giving a significant broad antimicrobial spectrum even at low MIC values can be readily obtained from antimicrobial agents of the same benzimidazole group. In particular, use of these in combination results in a significant antimicrobial property.

Incidentally, the one having thiazolyl group on benzimidazole ring may preferably be 2-(4-thiazolyl)-11H-benzimidazole and one having a carbamate group on benzimidazole ring may preferably be methyl 2-benzimidazole carbamate. Since two kinds, i.e., one having a thiazolyl group on the benzimidazole ring, 2-(4-thiazolyl)-1H-benzimidazole and another having a carbamate group on the benzimidazole ring, methyl 2-benzimidazole carbamate are used in combination, a significant antimicrobial property can be exhibited by a synergetic effect by the combined use. Further, 2-(4-thiazolyl)-1H-benzimidazole and methyl 2-benzimidazole carbamate are produced relatively easily and easily available, and are materials that have already been utilized and confirmed for their safety, so these can be readily utilized.

In the above aspect, the inorganic antimicrobial agent is preferably at least one of silver-based antimicrobial agent and zinc oxide.

Since at least one of silver-based antimicrobial agent and zinc oxide is used as the inorganic antimicrobial agent, significant antimicrobial effects can be easily exhibited. With the use of silver-based antimicrobial agent and zinc oxide in combination, inorganic antimicrobial agents of the same inorganic group can provide a synergetic effect when used in combination, so a more significant antimicrobial property can be easily obtained.

Silver-based antimicrobial agent is preferably zirconium or the salt thereof or zeolite each supporting silver thereon. When zirconium or the salt thereof or zeolite each supporting silver thereon is used as the silver-based antimicrobial agent, requisite minimum amount of silver (precious metal) is required, so that antimicrobial effects by the inorganic antimicrobial agent can be efficiently obtained and synergetic effects with the organic antimicrobial agent can be obtained, whereby the cost can be easily reduced.

The blend ratio between zirconium or the salt thereof or zeolite each supporting silver thereon and zinc oxide is preferably 1:1 to 1:10 in terms of mass ratio. Since zirconium or the salt thereof or zeolite each supporting silver thereon and zinc oxide are used in combination, inorganic antimicrobial agents of the same inorganic group can provide a synergetic effect when used in combination, so a more significant antimicrobial property can be easily obtained. Further, without impairing synergetic effects by combined use of the antimicrobial effect of inorganic antimicrobial agent itself and the antimicrobial effect of organic antimicrobial agent, the amount of silver (precious metal) can be reduced, which results in further reduced cost. Since the blend ratio between zirconium or the salt thereof or zeolite each supporting silver thereon and zinc oxide is 1:1 to 1:10 in terms of mass ratio, the amount of used silver can be reduced without impairing antimicrobial performance.

If the blend ratio of the zirconium or the salt thereof or zeolite each supporting silver thereon to the zinc oxide is 1 to less than 1, i.e., zinc oxide is in a smaller amount than 1:1 by mass, then a sufficient cost reduction by a decrease in the amount of silver to be used becomes difficult to obtain. Further, discoloration due to oxidation of silver may be exhibited. On the other hand, when zinc oxide is in a ratio of more than 1:10 by mass, there is the possibility that a sufficient antimicrobial action by silver will be difficult to obtain. Accordingly, the blend ratio between zirconium or the salt thereof or zeolite each supporting silver thereon and zinc oxide is preferably 1:1 to 1:10 in terms of mass ratio.

It is preferable that the blend ratio of the imidazole organic antimicrobial agent to the inorganic antimicrobial agent is 1:1 to 5:1 by mass. Since the blend ratio of the imidazole organic antimicrobial agent to the inorganic antimicrobial agent is set at 1:1 to 5:1 by mass, a significant synergetic effect in an antimicrobial action by use of an organic antimicrobial agent and an inorganic antimicrobial agent in combination as well as the antimicrobial actions of the organic antimicrobial agent by itself and the inorganic antimicrobial agent by itself can be properly exhibited.

If the blend ratio of the organic antimicrobial agent to the inorganic antimicrobial agent is less than 1 to 1, i.e., the organic antimicrobial agent is in a smaller amount than 1:1 by mass, there is the possibility that no broadening of the antimicrobial spectrum at a low MIC value will be obtained. On the other hand, when the organic antimicrobial agent is more than 5:1 by mass, the ratio of organic antimicrobial agent with slower initial antimicrobial performance and more easily-decreasing antimicrobial performance than inorganic antimicrobial agent is increased, which may result in failure in obtaining stable and significant antimicrobial performance from the start of the usage for a long time.

Accordingly, it is preferable that the blend ratio of the benzimidazole organic antimicrobial agent to the inorganic antimicrobial agent is 1:1 to 5:1 by mass.

In the present invention, the antimicrobial molding is preferably foam-molded.

In the above aspect, since curing material is used, the material can be easily foamed to be molded, which can be easily utilized by foam-molding as, for instance, shock absorber and heat insulator that can efficiently exhibit high antimicrobial effects.

The foam-molding may be achieved in any manner that can bring in air bubble in the molding, such as mixing foaming agent, supercritical foaming and bubbling in molding and solidifying the curing material.

A laminated body according to another aspect of the invention includes a sheet layer formed by molding the antimicrobial molding according to the above aspect of the invention.

According to the above aspect, the laminated body may preferably include laminated structure of a sheet layer formed by molding the antimicrobial molding according to the above aspect of the invention.

According to the above arrangement, the laminated body can be applied to various applications such as architectural material such as wallpaper and house wrap, food packages and adhesion tape having an adhesion layer on one side of the sheet layer.

Further, by providing a layer that inaccessibly covers the sheet layer on a surface side oft for instance, wallpaper, influence on human body sensitive to irritation can be prevented. Further, by providing the sheet layer in a covering manner on the surface of the molding to provide a laminated structure, high antimicrobial performance can be efficiently given to a molding having no antimicrobial performance with ease.

Incidentally, sheet-shaped molding used as waterproof liner can be provided in a form of adhering the sheet-shaped molding with a fabric (tarpaulin and the like) and a laminated body with further layer of resin sheet (i.e. resin sheet/fabric/resin sheet).

The laminated body of the above aspect includes woven fabric, knitted fabric, and multi-layer sheet such as synthetic leather and artificial leather laminated with non-woven fabric. If the laminated sheet is subjected to a natural organic substance treatment as well, further improvement in skin activity, touch and appearance can be resulted. The natural organic substance include: protein (and resolvent thereof) such as silk, collagen, keratin, feather, sericin, eggshell membrane, amino acid; polysaccharide such as chitin, chitosan, tea leaf, chondroitin and hyaluronan; and the like. Alternatively, biologically active agent such as vitamin and polyphenol may be used. In particular, combined use with protein processing such as silk and eggshell membrane is preferable since it is expected that the combination helps retention of skin moisture.

A heat insulator according to still another aspect of the invention includes a foam-molded body of the antimicrobial molding according to the above aspect of the invention.

In this aspect of the invention, the above-described antimicrobial molding is foam-molded.

Accordingly, since the curing material that constitute the antimicrobial molding is foam-molded, a heat-insulator that can efficiently exhibit high antimicrobial effects with ease.

A synthetic leather article according to further aspect of the invention includes the laminated body according to the above aspect of the invention, the laminated body including synthetic leather or an artificial leather.

According to this aspect of the invention, excellent antimicrobial performance as discussed in the antimicrobial molding of the present invention can be exhibited in the synthetic leather article.

### BEST MODE FOR CARRYING OUT THE INVENTION

An embodiment of antimicrobial molding according to the invention will be described below.

Though sheet-shaped antimicrobial resin sheet is taken in the present embodiment as an example of antimicrobial molding of the invention, the antimicrobial molding of the invention may not be formed in a sheet but may be provided in various forms. Further, the antimicrobial molding may not be provided as a single-layer sheet but may be provided as a multi-layer sheet. Furthermore, the antimicrobial molding may not be provided as a resin molding but may be provided as inorganic molding such as a concrete molding.

### [Arrangement of Antimicrobial Resin Sheet]

The antimicrobial resin sheet is, though application thereof is not specifically limited, applied on a component or a part used in an environment where fungus (including fungus, bacteria, algae) as microorganism is likely to propagate. Specifically, the antimicrobial resin sheet is directly used for various applications including architectural material such as wallpaper and house wrap, food packages and synthetic leather. Alternatively, the antimicrobial resin sheet is bonded or adhered on a surface of a target portion in a form of, for instance, adhesion tape having an adhesive layer, or, the antimicrobial resin sheet is merely held on the target portion without providing an adhesive layer.

The antimicrobial resin sheet is molded as a sheet using a known molding method such as injection molding, extrusion molding, blow molding and inflation molding.

The antimicrobial resin sheet contains a curing material and the antimicrobial composition containing at least two organic antimicrobial agents selected from imidazole organic antimicrobial agents and an inorganic agent.

Examples of the curing material are: hydraulic-setting synthetic resin such as silicone; hydraulic-setting inorganic material such as cement, mortar and plaster; thermoplastic synthetic resin such as polyethylene, polypropylene, urethane, nylon and vinyl; solvent-dispersing resin such as acryl, urethane, vinyl polyolefin and solvent-dissolving resin such as acryl, urethane and vinyl, the solvent-dispersing resin and the solvent-dissolving resin being solidified by removing solvent (water, organic solvent and the like); resin that initiates reaction or polymerization by two-pack mixing to be solidified such as epoxy resin; polymerized unsaturated polyester cross-linked by peroxide; and resin such as acrylate monomer and prepolymer that has reactive active group cured by irradiating light beam, ultraviolet, radiation ray or electron beam at a terminal end thereof.

There is no limitation on the material used for the layer provided on the side of surface layer of a multi-layer structure, which may be resin material, bark and paper. Specific examples of the material are polyethylene resin, polypropylene resin, polyurethane resin, polycarbonate resin, polystyrene resin, polyester resin such as polyethylene terephthalate, nylon (polyamide) resin, acryl resin, polyvinyl chloride resin, acrylonitorile-butadiene-styrene (ABS) resin, which may be singularly used or used in combination of two or more of the resins.

Incidentally, when a crystalline resin is used as resin material on the curing material or the resin material provided on surface side of a multi-layer structure, a resin material with relatively low crystallinity degree is preferably used. Such resin material with low crystallinity degree is preferable in that antimicrobial effects by the sheet layer containing the antimicrobial composition can be more easily exhibited by the antimicrobial composition contained in the resin material or through the surface-side layer.

The antimicrobial composition preferably contains two organic antimicrobial agents selected solely from imidazole organic antimicrobial agents and inorganic antimicrobial agent. It is especially preferable that the antimicrobial composition is composed of two organic antimicrobial agents selected solely from imidazole organic antimicrobial agents and the inorganic antimicrobial agent.

Such antimicrobial composition exhibits antimicrobial effects at a low MIC value against fungus (including fungus, bacteria, algae and the like) as a microorganism shown in tables 1 to 6 and shows significantly wide antimicrobial spectrum.

Specifically, even when the MIC value is set at a tight level of 50 ppm or lower, antimicrobial effect is shown to 214 fungi, 131 bacteria and 27 algae (confirmed at present). Tables 1 to 3 show fungi, Tables 4 and 5 show bacteria and Table 6 shows algae.

In Tables 1 to 6, Embodiment 1 shows a MIC value data for antimicrobial composition used in below-described Embodiment 1. Comparison A shows a MIC value data for antimicrobial composition mixing thiabendazole and carbendazim by 1:1. Comparison B shows a MIC value data for antimicrobial composition mixing silver-supporting zirconium phosphate (manufactured by TOAGOSEI CO., LTD, product name Novaron) and zinc oxide (chemical reagent manufactured by KANTO CHEMICAL CO., INC.) by 18:82. In Tables 1 to 6, blank sections in the Comparisons mean that no antimicrobial effects could be observed.

TABLE 1
(MIC value (unit: ppm))

| | | | Embodiment 1 | Comparison A | Comparison B |
|---|---|---|---|---|---|
| Fungi | 1 | Alternaria alternata | 1 | 1 | 250 |
| | 2 | Aspergillus awarnori | 1 | 1 | |
| | 3 | Aspergillus niger | 6 | 6 | 120 |
| | 4 | Aspergillus oryzae | 6 | 1 | 120 |
| | 5 | Aspergillus flavus | 3 | | |
| | 6 | Aspergillus versicolor | 10 | 5 | |
| | 7 | Aspergillus fumigatus | 3 | 3 | 250 |
| | 8 | Aspergillus nidulans | 3 | | |
| | 9 | Aspergillus glaucus | 3 | | |
| | 10 | Aspergillus terreus | 8 | | |
| | 11 | Aspergillus phoenicus | 8 | | |
| | 12 | Aspergillus tamari | 3 | 3 | 120 |
| | 13 | Aspergillus wentii | 3 | | |
| | 14 | Aspergillus restrictus | 3 | | |
| | 15 | Aspergillus ochraceus | 8 | | |
| | 16 | Aspergillus clavatus | 8 | | |
| | 17 | Aspergillus ustus | 1 | | |
| | 18 | Aspergillus candidus | 1 | 1 | 250 |
| | 19 | Aspergillus parasiticus | 1 | | |
| | 20 | Absidia corymbifera | 1 | | |
| | 21 | Aspergillus luchensis | 5 | | |
| | 22 | Absidia glauca | 5 | | |
| | 23 | Alternaria tenuis | 1 | | |
| | 24 | Alternaria pisi | 6 | | |
| | 25 | Alternaria candidus | 2 | | |
| | 26 | Alternaria brassicicola | 4 | 2 | 250 |
| | 27 | Aureobasidium pullulans | 2 | 2 | 500 |
| | 28 | Ascosphaera apis | 10 | | |
| | 29 | Aphanomyces cochlioides | 1 | | |
| | 30 | Aphanomyces raphani | 1 | | |
| | 31 | Botrytis cinera | 1 | 1 | 500 |
| | 32 | Byssochlamys nivea | 10 | | |
| | 33 | Candide albicans | 3 | 3 | 250 |
| | 34 | Cerespora beticola | 1 | | |
| | 35 | Cerespora musao | 1 | | |
| | 36 | Claviceps purpurea | 1 | | |
| | 37 | Colletotrichum trifolii | 1 | | |
| | 38 | Ceratocystis cora | 1 | | |
| | 39 | Chaetomium globosum | 3 | 2 | 500 |
| | 40 | Cladosporium cladosporioides | 6 | 5 | 250 |
| | 41 | Curvularia geniculata | 6 | | |
| | 42 | Chrysosporium thermophilum | 4 | | |
| | 43 | Candida guilliermondii | 1 | 1 | 125 |
| | 44 | Candida lipolytica | 1 | 1 | 125 |
| | 45 | Candida pelliculose | 1 | 1 | 125 |
| | 46 | Candida tropicalis | 1 | 1 | 125 |
| | 47 | Candida glabrata | 1 | 1 | 125 |
| | 48 | Candida acutus | 10 | 10 | 125 |
| | 49 | Candida utilis | 10 | 10 | 125 |
| | 50 | Cladosporium sphaerospermum | 3 | 3 | 250 |
| | 51 | Cladosporium herbarum | 3 | 3 | 250 |
| | 52 | Corticium rolfsii | 1 | | |
| | 53 | Colletotrichum phomoides | 1 | 1 | 120 |
| | 54 | Colletotrichum fragariae | 1 | 1 | 120 |
| | 55 | Colletotrichum arramentarium | 1 | 1 | 120 |
| | 56 | Colletotrichum lindemuthianum | 6 | | |
| | 57 | Ceratocystis ulmi | 1 | | |
| | 58 | Clostridium acetobutylicum | 8 | | |
| | 59 | Clostridium sporogenes | 10 | | |
| | 60 | Cladosporium carpophilum | 6 | | |
| | 61 | Curvularia lunata | 1 | | |
| | 62 | Chrysosporium keratinophilum | 4 | | |
| | 63 | Cryptococcus lutealus | 20 | | |
| | 64 | Chyptococcus neoformans | 10 | | |
| | 65 | Cladosporium resinae | 6 | | |
| | 66 | Cryptococcus albidas | 1 | | |
| | 67 | Chaetomium clivaceum | 1 | | |
| | 68 | Dactylium derdroides | 1 | | |
| | 69 | Diplodia natalensis | 1 | | |
| | 70 | Drechslera australiensis | 3 | | |

TABLE 2
(MIC value (unit: ppm))

| | | | Embodiment 1 | Comparison A | Comparison B |
|---|---|---|---|---|---|
| Fungi | 71 | Eurotium tonophilum | 1 | | |
| | 72 | Epicoccum purpurascens | 1 | | |
| | 73 | Eurotium repens | 2 | | |
| | 74 | Eurotium rubrum | 2 | | |
| | 75 | Eurotium chevalieri | 1 | | |
| | 76 | Eurotium amstelodami | 2 | | |
| | 77 | Emericella nidulans | 3 | | |
| | 78 | Exophiale jeanselmei | 3 | | |
| | 79 | Fusarium semitectum | 1 | | |
| | 80 | Fusarium oxysporum | 10 | | 200 |
| | 81 | Fusarium voseum | 1 | | |
| | 82 | Fusarium moniliforme | 1 | | |
| | 83 | Fusarium solani | 8 | | |
| | 84 | Fusarium roseum | 1 | | |
| | 85 | Fusarium nivale | 1 | | |
| | 86 | Fusarium avenaceum | 1 | | |
| | 87 | Fusarium acuminatum | 1 | | |
| | 88 | Fusarium proliferatum | 1 | | |
| | 89 | Fusarium graminearum | 1 | | |
| | 90 | Fhymatotricum omnivorum | 4 | | |
| | 91 | Geotricham candidum | 3 | | |
| | 92 | Geotricham lactus | 6 | | |
| | 93 | Gliocladium virens | 8 | | |
| | 94 | Glomerella cingulata | 6 | | |
| | 95 | Helminthosporium sp. | 6 | | |
| | 96 | Hormoderdrum pedrosoi | 3 | | |
| | 97 | Helminthosporium gramineum | 20 | | |
| | 98 | Lenzites trabea | 8 | | |
| | 99 | Lenzites trabae | 8 | | |
| | 100 | Lentinus lepideus | 8 | | |
| | 101 | Medurella mycetomii | 4 | | |
| | 102 | Microsporum canis | 3 | | |
| | 103 | Microsporum gypseum | 1 | | |
| | 104 | Microsporum audouini | 10 | | |
| | 105 | Mucor racemosus | 8 | | |
| | 106 | Myrothecium verrucaria | 4 | | |
| | 107 | Mucor mucedo | 4 | | |
| | 108 | Mucor pusillus | 4 | | |
| | 109 | Mucor spinescens | 1 | | |
| | 110 | Mucor rouxii | 2 | | |
| | 111 | Monascus ruber | 6 | | |
| | 112 | Monilia candida | 1 | | |
| | 113 | Monilia fructigena | 10 | | |
| | 114 | Monilia nigral | 1 | | |
| | 115 | Monilia laxa | 1 | | |
| | 116 | Menoniella echinita | 6 | | |
| | 117 | Neurospora crassa | 10 | | |
| | 118 | Nigrospora oryzae | 1 | | |
| | 119 | Neurospora sitophila | 3 | | |
| | 120 | Nigrospora sphaerica | 6 | | |
| | 121 | Ocuremonium charticola | 20 | | |
| | 122 | Penicillium frequentance | 1 | 1 | 500 |
| | 123 | Penicillium citrinum | 3 | 3 | 500 |
| | 124 | Penicillium variabile | 1 | 1 | 500 |
| | 125 | Penicillium purpurogenum | 1 | 1 | 1000 |
| | 126 | Penicillium glaucum | 1 | 1 | 500 |
| | 127 | Pullularia pullulans | 1 | | |
| | 128 | Penicillium roquerforiti | 3 | 3 | 500 |
| | 129 | Penicillium luteum | 3 | 3 | 500 |
| | 130 | Penicillium expansum | 3 | 3 | 500 |
| | 131 | Penicillium piscarium | 3 | 3 | 1000 |
| | 132 | Penicillium rugulosum | 3 | 3 | 500 |
| | 133 | Penicillium cyclopium | 3 | 3 | 500 |
| | 134 | Penicillium chrysosgenum | 3 | 3 | 500 |
| | 135 | Penicillium citreo-viride | 10 | | |
| | 136 | Penicillium notatum | 3 | 3 | 1000 |
| | 137 | Penicillium rubrum | 3 | 3 | 1000 |
| | 138 | Penicillium oxalicum | 8 | 8 | 500 |
| | 139 | Penicillium funiculosum | 10 | 10 | 500 |
| | 140 | Penicillium digitatum | 10 | 10 | 500 |

TABLE 3
(MIC value (unit: ppm))

| | | | Embodiment 1 | Comparison A | Comparison B |
|---|---|---|---|---|---|
| Fungi | 141 | Penicillium islandicum | 20 | 20 | 500 |
| | 142 | Penicillium nigricans | 3 | 3 | 500 |
| | 143 | Penicillium lilacinum | 20 | 20 | 500 |
| | 144 | Penicillium spinulosum | 3 | 3 | 500 |
| | 145 | Pestalotia adusta | 20 | | |
| | 146 | Pestalotia neglecta | 10 | | |
| | 147 | Phomopsis citri | 3 | | |
| | 148 | Penicillium steckii | 3 | | |
| | 149 | Phoma citricarpa | 3 | | |
| | 150 | Phoma terrestius | 3 | | |
| | 151 | Phoma glomerata | 3 | | |
| | 152 | Phoma pigmentivara | 3 | | |
| | 153 | Pichia membranaefaciens | 20 | | |
| | 154 | Peptococcus sp. | 10 | | |
| | 155 | Proteus mirabilis | 1 | 1 | 100 |
| | 156 | Phacidipycnus funfuracea | 6 | | |
| | 157 | Phomopsis fukushii | 1 | | |
| | 158 | Pythium debaryanum | 1 | | |
| | 159 | Pythium debaryanum | 1 | | |
| | 160 | Pythium aphanidermatam | 1 | | |
| | 161 | Phomopsis vexan | 1 | | |
| | 162 | Phytophthora megasperma | 1 | 1 | 100 |
| | 163 | Phytophthora nicotianae | 1 | 1 | 100 |
| | 164 | Phytophthora infestans | 1 | 1 | 100 |
| | 165 | Phytophthora capsici | 1 | 1 | 100 |
| | 166 | Plasmodiophora brassicae | 1 | | |
| | 167 | Pyrenochaeta licopersici | 1 | | |
| | 168 | Rhodotorula mimuta | 8 | | |
| | 169 | Rhodotorula muchilaginosa | 8 | | |
| | 170 | Rhodotorula texensis | 8 | | |
| | 171 | Rhodotorula glutinis | 8 | | |
| | 172 | Rhodotorula gulinis | 20 | | |
| | 173 | Rhodotorula lactosa | 20 | | |
| | 174 | Rhizopus nigricans | 3 | 3 | 500 |
| | 175 | Rhizopus oryzae | 3 | 1 | 500 |
| | 176 | Rhizopus storonifer | 3 | 2 | 500 |
| | 177 | Rhizopus delemar | 8 | 8 | 500 |
| | 178 | Rhizopus solani | 3 | | |
| | 179 | Rhizopus javanicus | 8 | | |
| | 180 | Sporotrichum shenki | 10 | | |
| | 181 | Stichococcus bacillavis | 10 | | |
| | 182 | Sclerotinia fructincola | 10 | | |
| | 183 | Saccharomycodes pasteurianus | 3 | | |
| | 184 | Stachybotrys sp. | 3 | | |
| | 185 | Spicaria Vlolacea | 3 | | |
| | 186 | Scolecobasidium constrictum | 8 | | |
| | 187 | Scedosporiurn apiospermum | 10 | 10 | 100 |
| | 188 | Syncephalastrum racemosum | 3 | | |
| | 189 | Stachybotrys chartrum | 3 | | |
| | 190 | Sporothrix schenckii | 1 | | |
| | 191 | Sclerotium cepivorum | 1 | | |
| | 192 | Sphaerotheca humuli | 1 | | |
| | 193 | Sclerotinia sclerotiorum | 1 | | |
| | 194 | Scopulariopsis brevicaulis | 10 | | |
| | 195 | Trichophyton mentagrophytes | 3 | 3 | 1000 |
| | 196 | Trichophyton gypseum | 10 | 10 | 1000 |
| | 197 | Trichophyton rubrum | 1 | 1 | 1000 |
| | 198 | Trichothecium roseum | 3 | 3 | 1000 |
| | 199 | Trichoderma viride | 6 | | |
| | 200 | Trichophyton ajelloi | 1 | 1 | 1000 |
| | 201 | Trichoderma koningii | 3 | | |
| | 202 | Trichoderma T-1 | 1 | | |
| | 203 | Trichoderma harzianum | 6 | | |
| | 204 | Tolulopsis candida | 6 | | |
| | 205 | Trichosporum cutaneum | 1 | | |
| | 206 | Trichoderma lignorum | 1 | | |
| | 207 | Ulocladium atrum | 4 | | |
| | 208 | Ustilago zeae | 10 | | |
| | 209 | Venticillium albo-atrum | 10 | | |
| | 210 | Verticillium dahliae | 1 | | |
| | 211 | Wallemia sebi | 1 | | |
| | 212 | Tyromyces palustris | 1 | | |
| | 213 | Trametes versicolor | 1 | | |
| | 214 | Serpula lacrymans | 1 | | |

TABLE 4
(MIC value (unit: ppm))

| | | | Embodiment 1 | Comparison A | Comparison B |
|---|---|---|---|---|---|
| Bacteria | 1 | Alcaligenes faecalis | 1 | 8 | 80 |
| | 2 | Alcaligenes viscolactis | 1 | 8 | 80 |
| | 3 | Ascophyta pisi | 10 | | |
| | 4 | Autotrophic bacteria | 20 | | |
| | 5 | Aster yellows | 1 | | |
| | 6 | Acinetobacter calcoaceticus | 4 | | |
| | 7 | Achrcmobacter gulyatus | 1 | | |
| | 8 | Aerobacter aerogenes | 1 | | |
| | 9 | Aerobacter cloacae | 1 | 8 | 80 |
| | 10 | Blastomyces italicum | 1 | | |
| | 11 | Bacillus cereus | 1 | 8 | 80 |
| | 12 | Bacillus mycoides | 1 | 8 | 80 |
| | 13 | Bacillus subtillis | 10 | 10 | 80 |
| | 14 | Bacillus megaterrium | 10 | 10 | 80 |
| | 15 | Bacillus anthracis | 10 | 10 | 80 |
| | 16 | Bacillus punctatum | 10 | 10 | 80 |
| | 17 | Bacterium vulgaro | 1 | | |
| | 18 | Bacterium pyocyaneum | 1 | | |
| | 19 | Blastomyces deematidis | 1 | | |
| | 20 | Bacterroid fragilis | 3 | | |
| | 21 | Campylobacter fetus | 3 | | |
| | 22 | Clostridium perfringens | 3 | | |
| | 23 | Clostridium difficile | 3 | | |
| | 24 | Corticium fuciforme | 3 | | |
| | 25 | Clostridium botulinum | 3 | | |
| | 26 | Cloechera apiculata | 10 | | |
| | 27 | Cellulomonas iugis | 1 | | |
| | 28 | Campylobacter jejuni/coli | 10 | | |
| | 29 | Dactylium dendroides | 3 | | |
| | 30 | Diplodia viticol | 3 | | |
| | 31 | Debaryamyces hansenii | 15 | | |
| | 32 | Desulfovibrio desullfuricans | 1 | | |
| | 33 | Endothia paracitica | 1 | | |
| | 34 | Escherichia coli | 15 | 15 | 400 |
| | 35 | Enterobacter aerogenes | 1 | | |
| | 36 | Enterobacter clocae | 10 | | |
| | 37 | Erwinia carotovora | 1 | | |
| | 38 | Fusobacterium nucleatum | 1 | | |
| | 39 | Flavobacterium aminogenes | 10 | | |
| | 40 | Flavobacterium meningosepticum | 1 | | |
| | 41 | Gluconobacter suboxydans | 10 | | |
| | 42 | Hansenula anomala | 10 | | |
| | 43 | Klebsiella oxytoca | 10 | | |
| | 44 | Klebsiella pneumoniae | 3 | | |
| | 45 | Lactbacillus acidophilus | 8 | | |
| | 46 | Lactbacillus planntarum | 10 | | |
| | 47 | Listeria monocytogenes | 10 | | |
| | 48 | Legionella pneamophila | 1 | | |
| | 49 | Leptospira interrogans | 10 | | |
| | 50 | Lepiota criststa | 1 | | |
| | 51 | Lepiota castanae | 1 | | |
| | 52 | Lactbacillus bulgericus | 1 | | |
| | 53 | Micrococcus glatamicus | 15 | 6 | 120 |
| | 54 | Microbacterrium tuberculosis | 15 | | |
| | 55 | Micrococcus albus | 1 | 80 | 120 |
| | 56 | Micrococcus aquilis | 1 | 80 | 120 |
| | 57 | Micrococcus conglomerates | 1 | 8 | 120 |
| | 58 | Micrococcus varians | 1 | 8 | 120 |
| | 59 | Paecilomyces lilacinus | 10 | 8 | 80 |
| | 60 | Podiococcus soyae | 10 | | |
| | 61 | Podiococcus acidilactici | 10 | | |
| | 62 | Pseudomonas aeruginosa | 20 | 8 | 125 |
| | 63 | Pseudomonas fluresceus | 3 | 8 | 125 |
| | 64 | Paecilomyces variotti | 2 | | |
| | 65 | Phaffia rhodozyma | 10 | | |
| | 66 | Pichia anomala | 10 | | |
| | 67 | Pichia membranaefaciens | 10 | | |
| | 68 | Proteus vulgaris | 15 | | |
| | 69 | Pythium vanterpoolii | 1 | 1 | 20 |
| | 70 | Phyrasium cinereum | 1 | | |
| | 71 | Propionibacterium aces | 1 | | |
| | 72 | Propionibacterium shermanii | 1 | | |
| | 73 | Podosphaera leucotricha | 1 | 8 | 20 |
| | 74 | Pseudomonas syringae | 3 | 8 | 125 |
| | 75 | Pseudomonas solanacearum | 3 | 8 | 125 |

TABLE 5
(MIC value (unit: ppm))

| | | | Embodiment 1 | Comparison A | Comparison B |
|---|---|---|---|---|---|
| Bacteria | 76 | Paracolabactrum aerogenoides | 1 | 3 | 120 |
| | 77 | Rhizoctonia violacea | 1 | 3 | 20 |
| | 78 | Rhizoctonia solani | 1 | 8 | 20 |
| | 79 | Rickettsia rickettsii | 1 | | |
| | 80 | Ruminococcus | 1 | | |
| | 81 | Scleotina scleotiorum | 1 | | |
| | 82 | Sporobolomyces roseus | 10 | | |
| | 83 | Streptococcus lactis | 10 | | |
| | 84 | Schizosaccharomyces pombe | 10 | | |
| | 85 | Saccharomycodes ludwigii | 10 | | |
| | 86 | Serratia marcesens | 10 | | |
| | 87 | Staphylococcus aureus | 10 | 8 | 125 |
| | 88 | Salmonella typhimurium | 1 | 8 | |
| | 89 | Streptoverticillum reticulum | 5 | | |
| | 90 | Staphylococcus faecalis | 5 | 8 | 60 |
| | 91 | Salmonella enteritidis | 3 | 8 | 60 |
| | 92 | Salmonella enterrica | 3 | 8 | 60 |
| | 93 | Salmonella arizonae | 3 | 8 | 60 |
| | 94 | Salmonella paratyphi | 3 | 8 | 60 |
| | 95 | Salmonella choleraesuis | 3 | 8 | 60 |
| | 96 | Streptococcus agalactiae | 8 | | |
| | 97 | Serratia marcesceus | 1 | | |
| | 98 | Serratia liguefaciens | 1 | | |
| | 99 | Saccharomyces cerevisiae | 3 | 10 | 120 |
| | 100 | Sugeran mosaic | 1 | | |
| | 101 | Staphylococcus epidermidis | 1 | 8 | 125 |
| | 102 | Staphylococcus hominis | 1 | 8 | 125 |
| | 103 | Staphylococcus agalactiae | 1 | 8 | 125 |
| | 104 | Staphylococcus pneumoniae | 1 | 8 | 125 |
| | 105 | Staphylococcus pyogenes | 1 | 8 | 125 |
| | 106 | Serratia salinaria | 1 | | |
| | 107 | Salmonella typhosa | 1 | 8 | 120 |
| | 108 | Sarcina flava | 1 | | |
| | 109 | Sarcina latea | 1 | | |
| | 110 | Sporocytohaga myxococcoides | 1 | | |
| | 111 | Torula nigra | 1 | 16 | 100 |
| | 112 | Thermoactinomyces vulgaris | 1 | | |
| | 113 | Thiobacillus asidophilus | 1 | 4 | 20 |
| | 114 | Thiobacillus delicatus | 1 | 4 | 20 |
| | 115 | Thiobacillus denitrificans | 1 | 4 | 20 |
| | 116 | Thiobacillus ferrooxidans | 1 | 4 | 20 |
| | 117 | Thiobacillus intermedius | 1 | 4 | 20 |
| | 118 | Thiobacillus kabolis | 1 | 4 | 20 |
| | 119 | Thiobacillus neapolitans | 1 | 4 | 20 |
| | 120 | Thiobacillus nvellus | 1 | 4 | 20 |
| | 121 | Thiobacillus perometabolis | 1 | 4 | 20 |
| | 122 | Thiobacillus rubellus | 1 | 4 | 20 |
| | 123 | Thiobacillus thiooxidans | 1 | 4 | 20 |
| | 124 | Thiobacillus thioparus | 1 | 4 | 20 |
| | 125 | Thiobacillus thermophilica imschenetskii | 1 | 4 | 20 |
| | 126 | Thiobacillus versutus | 1 | 4 | 20 |
| | 127 | Vibrio ulnificus | 1 | 8 | 20 |
| | 128 | Venturia inaequalis | 1 | | |
| | 129 | Yersinia enterocolitica | 1 | | |
| | 130 | corynebacterium diphtheriae | 0.2 | 1 | 20 |
| | 131 | corynebacterium glutamicum | 0.2 | 1 | 20 |

TABLE 6
(MIC value (unit: ppm))

| | | | Embodiment 1 | Comparison A | Comparison B |
|---|---|---|---|---|---|
| Algae | 1 | Anacystis nidulans | 10 | | |
| | 2 | Anacystis montana | 10 | | |
| | 3 | Anacystis thermale | 10 | | |
| | 4 | Anabaena sp. | 10 | | |
| | 5 | Ankistrodesmus angustus | 10 | | |
| | 6 | Batrachospermum sp. | 10 | | |
| | 7 | Chlorella vulgaris | 10 | | |
| | 8 | Cladophora glomerata | 10 | | |
| | 9 | Chlamydomonas reinhardii | 10 | | |
| | 10 | Chlorococcum sp. | 10 | | |
| | 11 | Calothrix parietina | 10 | | |
| | 12 | Cylindrocapsa sp. | 10 | | |
| | 13 | Chlorella emersonii | 10 | | |
| | 14 | Hormidium sp. | 10 | | |
| | 15 | Hildenbrandia sp. | 10 | | |
| | 16 | Mesotaenium sp. | 10 | | |
| | 17 | Nostocales sp. | 10 | | |
| | 18 | Navicula sp. | 10 | | |
| | 19 | Oscillatoria lutea | 10 | | |
| | 20 | Pleurococcus sp. | 10 | | |
| | 21 | Scytonema hofmanii | 10 | | |
| | 22 | Sehizothrix sp. | 10 | | |
| | 23 | Tribonema sp. | 10 | | |
| | 24 | Trentepohlia odorata | 10 | | |
| | 25 | Trentepohlia aurea | 10 | | |
| | 26 | Ulotrichaceae sp. | 10 | | |
| | 27 | Zygogonium sp. | 10 | | |

Examples of imidazole organic antimicrobial agent include benzimidazole carbamate compounds, sulfur-atom-containing benzimidazole compounds, benzimidazole cyclic compound derivatives and the like.

Examples of benzimidazole carbamate compounds include methyl 1H-2-benzimidazole carbamate, methyl 1-butylcarbamoyl-2-benzimidazole carbamate, methyl 6-benzoyl-1H-2-benzimidazole carbamate, and methyl 6-(2-thiophenecarbonyl)-1H-2-benzimidazole carbamate.

Examples of the sulfur-atom-containing benzimidazole compound include 1H-2-thiocyanomethylthiobenzimidazole and 1-dimethylaminosulfonyl-cyano-4-bromo-6-trifluoromethylbenzimidazole.

Examples of the benzimidazole cyclic compound derivatives include 2-(4-thiazolyl)-1H-benzimidazole, 2-(2-chlorophenyl)-1H-benzimidazole, 2-(1-(3,5-dimethylpyrazolyl))-1H-benzimidazole, and 2-(2-furyl)-1H-benzimidazole.

At least two imidazole organic antimicrobial agents are selected from only among imidazole organic antimicrobial agents, which are used in combination herein. Even using the antimicrobial agents belonging to the same group, use of two different kinds of antimicrobial agents can create a synergetic effect in the antimicrobial effect on microorganisms. In particular, it is preferable to use one having a thiazolyl group on the benzimidazole ring and one having a carbamate group on the benzimidazole ring since a significant synergetic effect can be obtained.

Examples of the thiazolyl group include 2-thiazolyl, 4-thiazolyl, and 5-thiazolyl, Examples of the carbamate group include carbamate groups in which a hydrocarbon group therein is preferably an alkyl group such as a methyl group, an ethyl group, an n-2propyl group, or an iso-propyl group, and particularly preferably a methyl group or an ethyl group.

A specific example of the compound having a thiazolyl group includes 2-(4-thiazolyl)-1H-benzimidazole (Thiabendazole (TBZ)). Specific examples of the compound having a carbamate group include methyl-2-benzimidazole methyl carbamate (Carbendazim (BCM)) and methyl ethyl-2-benzimidazole carbamate. It is particularly preferable that 2-(4-thiazolyl)-1H-benzimidazole and 2-benzimidazole methyl carbamate be used, because they have a relatively high heat stability, can easily be used especially as a resin molding, has already been used as a fungicide (food additive) for grapefruit, orange, banana, or the like, and was found to be a material which provides a relatively few influence on a human body.

The imidazole-based organic antimicrobial agent is preferable since it contains no halogen, so that it generates no toxic substance such as dioxin and thus gives no adverse influence on environment even when the antimicrobial composition or the antimicrobial resin sheet as the antimicrobial molding is subjected to incineration disposal. The imidazole organic antimicrobial agent is preferable since it causes no inconvenience such as corrosion of metallic parts in a production line such as metallic molds when an antimicrobial resin sheet is molded from a resin material containing the antimicrobial composition, so the manufacturing facility requires no apparatus that are made of a special material, which results in simplification of manufacturing facility, improvement in productivity and reduction in apparatus cost.

Further, the imidazole organic antimicrobial agent is substantially insoluble in water, so it is free of the inconvenience that the antimicrobial agent is flown away under use conditions such as being exposed to rains and dews, thus failing to stably provide antimicrobial property for a long period of time. Further, it becomes easier to mix the imidazole organic antimicrobial agent with the resin material well to provide a molding having an antimicrobial property, and general versatility can also be increased with ease.

On the other hand, examples of the inorganic antimicrobial agent that can be used include inorganic metal compounds such as cuprous oxide, copper powder, copper thiocyanate, copper carbonate, copper chloride, copper sulfate, zinc oxide, zinc sulfate, nickel sulfate, and copper-nickel alloys, and zirconium phosphate, metal-supported zeolite, or a salt thereof such as zirconium phosphate. In particular, zirconium phosphate having supported thereon silver or copper as the metal is preferable and more preferably zirconium phosphate having supported thereon silver which is a silver-based antimicrobial agent having a high antimicrobial property is used. Note that the silver-based antimicrobial agent is not limited to a supported form but elemental metal silver may also be used.

Zirconium phosphate or zeolite having supported thereon a metal such as silver or copper is preferable since it has excellent safety to human body, a high antimicrobial rate, and excellent antimicrobial performance and also it provides a reduction in cost by supporting silver, which is a precious metal, on zirconium phosphate or zeolite.

When silver-supporting zirconium phosphate or zeolite is used, it is more preferable to use zinc oxide in combination. Use of the silver-supporting zirconium phosphate and zinc oxide in combination is preferable since antimicrobial effects by the silver-supporting zirconium phosphate by itself and of zinc oxide by itself can be obtained and, simultaneously, inorganic antimicrobial agents of the same inorganic group can provide a synergetic effect when used in combination, so a more significant antimicrobial property can be obtained. Use of the silver-supporting zirconium phosphate or zeolite is preferable since its combined use with zinc oxide can decrease the content of the silver-supporting zirconium phosphate or zeolite, so that a decrease in cost due to a decreased usage of silver, which is a precious metal, can be readily obtained. Further, discoloration due to oxidation of silver can be prevented.

It is preferable that the blend ratio of the imidazole organic antimicrobial agent to the inorganic antimicrobial agent in the antimicrobial composition is 1:1 to 5:1, in particular, 2:1 by mass.

If the blend ratio of the organic antimicrobial agent to the inorganic antimicrobial agent is less than 1 to 1, i.e., the organic antimicrobial agent is in a smaller amount than 1:1 by mass, there is the possibility that no broadening of the antimicrobial spectrum at a low MIC value will be obtained. On the other hand, when the organic antimicrobial agent is more than 5:1 by mass, it is possible that initial antimicrobial performance is delayed as compared with the inorganic antimicrobial agent. Accordingly, it is preferable that the blend ratio of the benzimidazole organic antimicrobial agent to the inorganic antimicrobial agent be set at 1:1 to 5:1 by mass to allow a significant synergetic effect in an antimicrobial action by use of an organic antimicrobial agent and an inorganic antimicrobial agent in combination as well as the antimicrobial actions of the organic antimicrobial agent by itself and the inorganic antimicrobial agent by itself to be properly exhibited.

Further, when 2-(4-thiazolyl)-1H-benzimidazole and methyl 2-benzimidazole carbamate are used in combination as an imidazole organic antimicrobial agent, the blend ratio thereof is preferably set to 1:1 to 5:1 by mass.

Here, when the blend ratio of 2-(4-thiazolyl)-1H-benzimidazole to methyl 2-benzimidazole carbamate is less than 1:1 by mass or more than 5:1 by mass, the number of antimicrobial spectrum capable of indicating an antimicrobial action with a low MIC value may reduce, accordingly, additive amounts of the antimicrobial composition may increase. For this reason, the blend ratio of 2-(4-thiazolyl)-1H-benzimidazole to methyl 2-benzimidazole carbamate is preferably set to 1:1 to 5:1 by mass.

When the silver-supporting zirconium phosphate or zeolite and zinc oxide are used in combination as the inorganic antimicrobial agent, the blend ratio of the silver-supporting zirconium phosphate to zinc oxide is set at preferably 1:1 to 1:10, more preferably about 1:2.

If the blend ratio of the silver-supporting zirconium phosphate or zeolite to the zinc oxide is 1 to less than 1, i.e., zinc oxide is in a smaller amount than 1:1 by mass, then a sufficient cost reduction by a decrease in the amount of silver to be used becomes difficult to obtain. Also, there is the possibility that discoloration due to oxidation of silver may arise. On the other hand, when zinc oxide is in a ratio of more than 1:10 by mass, there is the possibility that a sufficient antimicrobial action by silver will be difficult to obtain, so addition amount of the antimicrobial composition will be increased. Accordingly, it is preferable that the blend ratio of the silver-supporting zirconium or zeolite to the zinc oxide is set to 1:1 to 1:10 by mass to properly exhibit a significant synergetic effect in an antimicrobial action by the combined use.

It is preferable that the antimicrobial resin sheet of the present invention contains the antimicrobial composition in an amount of 0.01 mass % or more and 10.0 mass % or less. More preferably, the antimicrobial resin sheet contains the antimicrobial composition in an amount of 0.05 mass % or more and 2.0 mass % or less.

If the content of the antimicrobial composition is less than 0.01 mass %, there is the possibility that sufficient antimicrobial property cannot be obtained. On the other hand, if the content of the antimicrobial composition is more than 10.0 mass %, while no prominent change in antimicrobial performance can be observed, there is the possibility that: strength of the antimicrobial resin sheet as the moldings may be decreased; appearance such as surface smoothness is hindered; and the characteristics of the molding is deteriorated or the workability upon molding is decreased. Therefore, it is preferable that the content of the antimicrobial composition be set to 0.01 mass % or more and 10.0 mass % or less in order to reduce production cost due to increase in the content of the antimicrobial composition while achieving sufficient antimicrobial performance with least required content.

### EFFECTS AND ADVANTAGES OF EMBODIMENT

The antimicrobial molding of the present invention including the antimicrobial resin sheet contains an antimicrobial composition using: at least two imidazole organic antimicrobial agents that contain no halogen group and exhibits no skin irritation; and inorganic antimicrobial agent in combination. Accordingly, in addition to synergetic effects by using an organic antimicrobial agent and an inorganic antimicrobial agent in combination, additional synergetic effect due to usage of two organic antimicrobial agents from the same imidazole organic antimicrobial agent (especially due to usage of only two organic antimicrobial agents).

Accordingly, the resin molding containing the antimicrobial composition can exhibit significantly broad antimicrobial spectrum due to the combination solely of imidazole antimicrobial agents, which can by no means be expected from a conventional knowledge where chemically different antimicrobial agents are used in order to broaden the antimicrobial spectrum. Further, by inclusion of the antimicrobial composition that shows negative skin irritation, high safety, extremely low influence on human body and the environment and broad antimicrobial spectrum at a low minimum inhibitory concentration (MIC value) on account of synergetic effects, which efficiently achieves high antimicrobial action.

Since two types of imidazole organic antimicrobial agents, i.e. one having thiazolyl group on the benzimidazole ring and one having a carbamate group on the benzimidazole ring are used in combination, antimicrobial effects having little adverse influence on the human body and environment and giving a significant broad antimicrobial spectrum even at low MIC values can be readily obtained from antimicrobial agents of the same benzimidazole group. In particular, use of these in combination results in a prominent antimicrobial property.

In particular, since two kinds, i.e., one having a thiazolyl group on the benzimidazole ring, 2-(4-thiazolyl)-1H-benzimidazole and another having a carbamate group on the benzimidazole ring, methyl 2-benzimidazole carbamate are used in combination, a prominent antimicrobial property can be exhibited by a synergetic effect by the combined use. Further, 2-(4-thiazolyl)-1H-benzimidazole and methyl 2-benzimidazole carbamate are produced relatively easily and easily available, and are materials that have already been utilized and confirmed for their safety, so these can be readily utilized to increase general versatility.

Further, according to the antimicrobial composition of the present invention, a prominent antimicrobial property can be readily obtained since at least one of the silver-supporting zirconium phosphate and zinc oxide that can provide a synergetic effect with the imidazole organic antimicrobial agent is used as the inorganic antimicrobial agent. In particular, use of the silver-supporting zirconium phosphate and zinc oxide in combination can provide antimicrobial actions by the silver-supporting zirconium phosphate by itself and of the zinc oxide by itself and, in addition, a synergetic effect in an antimicrobial action by these inorganic antimicrobial agents of the same group, thus exhibiting a more prominent antimicrobial property. Further, use of the silver-supporting zirconium phosphate and zinc oxide in combination can decrease the amount of silver, which is a precious metal, without deteriorating its antimicrobial property, so that cost can be decreased more easily.

Further, as a form of using silver showing a high antimicrobial property, a form is used in which silver is supported on zirconium phosphate. As a result, the antimicrobial action of silver, which is a precious metal, can be exhibited with a minimum amount of silver, so the synergetic effect between the antimicrobial action by the inorganic antimicrobial agent and the antimicrobial action by the organic antimicrobial agent can be efficiently exhibited to more readily decrease cost.

The average particle size of the antimicrobial composition is controlled to be 1 μm or less.

Accordingly, dispersibility to the curing material can be improved and the compound can be properly contained with ease where surface smoothness of the molding can be ensured and strength reduction when being formed into a sheet shape can be restrained. Accordingly, stable and excellent antimicrobial effects can be properly exerted on the moldings with ease.

Incidentally, when the antimicrobial composition is kneaded into resin, a high-concentration master batch may preferably be prepared and kneaded with the same resin in advance. For instance, if the antimicrobial composition is added to polypropylene resin in an amount of 0.25% by mass, a master batch containing about 2.5% by mass of antimicrobial composition may preferably be prepared with the same polypropylene resin and the master batch may be diluted by ten times before being extrusion-molded. The dilution ratio may be changed in terms of moldability and economic efficiency.

On the other hand, when the antimicrobial composition is added to a resin containing liquid plasticizer (e.g. polyvinyl chloride: PVC), the antimicrobial composition may be preliminarily dispersed within the plasticizer in addition to or in place of the resin master batch in order to add the antimicrobial composition. Since liquid plasticizer is used, powder can be easily dispersed into the microbial compound and excellently mixed to PVC. There is no special limitation in the usable plasticizer, where various plasticizer including DOP (di-2-ethylhexyl phthalate) and DIDP (di-isodecyl phthalate) can be used.

When a resin dissolved in a solvent (e.g. polyurethane (PU)) is used, the antimicrobial composition may be preliminarily dispersed at a high concentration in an organic solvent such as dimethylformamide before being blended into resin solution. There is no limitation in usable organic solvent, where ketone and alcohol solvent may alternatively be used. Incidentally, the solvent can be selected according to characteristics of resin type and reaction type. For instance, since two-pack reactive polyurethane causes isocyanate cross-linking reaction, alcohol cannot be used.

Further, the antimicrobial composition is preferably contained in an amount between and including 0.01% and 10.0% by mass. When the antimicrobial composition is contained in an amount between and including 0.01% and 10.0% by mass, a molding capable of exhibiting prominent antimicrobial properties can be provided without impairing characteristics such as strength and appearance thereof.

When thermoplastic synthetic resin such as polyethylene (PE), polypropylene (PP), urethane, nylon, vinyl is used as the curing material, the antimicrobial composition can be easily molded into a desired shape by various methods such as extrusion, injection and casting after heating the antimicrobial composition and mixing with the thermoplastic resin, whereby moldings that exhibit high antimicrobial performance can be efficiently obtained.

When resin material such as epoxy resin that initiates reaction and polymerization by two-pack mixing is used as the curing material, the antimicrobial composition can be easily molded into a desired shape by various methods such as extrusion, injection and casting after mixing the antimicrobial composition with the two-pack, whereby moldings that exhibit high antimicrobial performance can be efficiently obtained.

Alternatively, when a resin such as acrylate monomer and prepolymer that is cured by irradiation of light, ultraviolet, radiation or electron and includes reactive active group at the terminal thereof, moldings that exhibit high antimicrobial performance can be efficiently obtained only by mixing the antimicrobial composition with the curing material, which is molded into a desired shape and, subsequently, is cured by irradiating light beam, ultraviolet, radiation ray or electron beam.

### MODIFICATION(S) OF EMBODIMENT

Note that the above-mentioned embodiment is one of embodiments of the present invention. It should be understood that the present invention is not limited to the embodiment and variations and improvements may be embraced by the present invention as far as objects and effects of the present invention are attained. Specific structures and shapes in practicing the present invention may be replaced without problems by other structures and shapes as far as the objects and effects of the present invention are attained

The constitution in which the antimicrobial composition of the present invention is made to be contained in an antimicrobial resin sheet has exemplified above. However, as mentioned above, the molding is not limited to one in the form of a sheet but may be various moldings such as a film, a fiber, an injection molding, and a blow molding. For instance, the antimicrobial composition can be molded as desired in accordance with specific applications, including: wood material; floor material; water-related utensils such as kitchen equipment (e.g. a washing machine, a refrigerator, a dish dryer, a chopping board, a water-cut bag and a water purifier) and toilet facilities (e.g. toilet seat, toilet bowl and cleaning tool); feed store (e.g. silo); leather article; artificial leather article including synthetic and synthetic leather articles; wall paper; air-conditioner air-path component structuring air-conditioning path of an air-conditioner; house wrap; roof material; textile products (apron, cloth piece, hospital service uniform, furniture cloth, curtain, and the like); heat insulator or shock absorber (such as shoe insole) that is foamed during molding process.

Though the antimicrobial composition is exemplarily mixed into a curing material before being molded in the above embodiment, an antimicrobial molding may be prepared by, for instance, impregnating antimicrobial composition solution to a molding. By controlling the particle size of the antimicrobial composition at 1 μm or smaller, the antimicrobial composition can be easily infiltrated into polyethylene and the like, whereby approximately the same performance can be exhibited as an antimicrobial composition of which material is mixed before being molded.

The solution of the antimicrobial composition may use any solvent that can disperse or dissolve the antimicrobial composition such as water and organic solvent.

In order to impregnate the antimicrobial composition, various methods may be used, including: painting including brush painting, roller painting and spray painting; dipping such as so-called dip coating; decompressed dipping; various coating processes such as knife coating, spray coating, gravure coating, flow coating, die coating and comma coating; and printing such as screen printing, pad printing, offset printing and inkjet printing, whereby the solution of the antimicrobial composition is adhered on a surface of a molding.

The antimicrobial composition may be used in combination with the other function-applying agent. The function-applying agent include, for instance: water repellant, SR treatment agent, softening agent and natural-organic-substance treatment agent. The natural organic substance include: protein (and resolvent thereof) such as silk, collagen, keratin, feather, sericin, eggshell membrane, amino acid; polysaccharide such as chitin, chitosan, tea leaf, chondroitin and hyaluronan; and the like. Alternatively, biologically active agent such as vitamin and polyphenol may be used. In particular, it is expected that combination with protein such as silk and eggshell membrane helps retention of skin moisture.

Further, the imidazole organic antimicrobial agent is not limited to 2-(4-thiazolyl)-1H-benzimidazole and methyl 2-benzimidazole carbamate, and constitutions in which various benzimidazole compositions as mentioned above are combined may be applied.

Further, respective blend ratios may be set appropriately corresponding to portions to which the antimicrobial agent is to be applied or applications.

Specific structure and shapes in practicing the present invention may be replaced by other structures and the like as far as the objects of the present invention are achieved.

### SPECIFIC EXPERIMENTS

The present invention will be explained below in more detail by way of examples, comparisons, and the like. However, the present invention should not be construed as being limited to the examples and the like.

### Experiment 1

Antimicrobial effects were tested on a multi-layer resin laminate (synthetic leather article) having sheet layers as an example of the antimicrobial molding of the present invention while varying the ratio of respective components.

### (Sample) Embodiment 1, Comparisons 1-4

Commercially available thiabendazole (obtained from KANTO CHEMICAL CO., INC as chemical reagent) and carbendazim (obtained from KANTO CHEMICAL CO., INC as chemical reagent) as imidazole organic antimicrobial agent, silver-supporting zirconium phosphate (manufactured by TOAGOSEI CO., LTD, product name Novaron) and zinc oxide (obtained from KANTO CHEMICAL CO., INC as chemical reagent) as inorganic antimicrobial agent were blended by a ratio of 33:33:6:28 to prepare an antimicrobial composition.

The prepared antimicrobial composition was added to dimethylformamide to be contained by 2.8% by mass, which was churned and mixed by an azihomomixer (manufactured by PRIMIX Corporation, product name T.K. ROBOMICS) so that average particle size became 0.8 μm or smaller (measured by a measuring instrument Microtrac MT3300 (product name) manufactured by NIKKISO CO., LTD) to prepare antifungal dispersion liquid.

Silicone modified polycarbonate polyurethane resin (manufactured by Dainichiseika Color & Chemicals Mfg. Co., Ltd., product name RESAMINE NES9950) was diluted to have 10 wt % of nonvolatile component with dimethyformaldehyde/methylethylketone=1/1 solution to prepare resin solution of curing material to be a leather surface layer. 1 g of the antifungal dispersion liquid was added to 100 g of the resin solution, which was sufficiently churned and mixed by a mixer (manufactured by PRIMIX Corporation, product name T.K. ROBOMICS) to prepare molding concentrate solution.

The prepared molding concentrate solution was coated on a release paper with bar coating at 100 g/m²-wet, which was dried at 10° C. for 10 minutes to form the surface layer as the sheet layer of the antimicrobial molding.

The surface layer was adhered on a fabric base using a mangle, which was used as a test piece of a resin laminate according to example 1 of PU (polyurethane) leather as synthetic leather. In other words, the resin laminate had three-layer construction of fabric base, adhesion layer and surface layer (sheet layer).

Commercially available thiabendazole (obtained from KANTO CHEMICAL CO., INC as chemical reagent) and carbendazim (obtained from KANTO CHEMICAL CO., INC as chemical reagent) as imidazole organic antimicrobial agent, silver-supporting zirconium phosphate (manufactured by TOAGOSEI CO., LTD, product name Novaron) as inorganic antimicrobial agent and zinc oxide (obtained from KANTO CHEMICAL CO., INC as chemical reagent) were blended by a ratio of 33:33:6:28 and added into DOP (PVC plasticizer) to be contained at 0.5% by mass, which was churned and mixed by an azihomomixer (manufactured by PRIMIX Corporation, product name T.K. ROBOMICS) so that average particle size became 0.8 μm or smaller (measured by a measuring instrument Microtrac MT3300 (product name) manufactured by NIKKISO CO., LTD) to prepare antimicrobial composition dispersion liquid. Subsequently, polyvinyl chloride resin (PVC) and the antimicrobial composition dispersion liquid were mixed at a ratio of 1:1, which was kneaded by a banbury mixer and was molded in a sheet-shape by a calendar roller. The sheet was adhered to a fabric base to prepare a test piece of resin laminate of PVC leather (artificial leather) (example 1).

Resin laminate according to comparison 1 was prepared without adding the antimicrobial composition in Embodiment 1. Resin laminate according to comparison 2 was prepared using thiabendazole of Embodiment 1 in place of the antimicrobial composition in Embodiment 1. Resin laminate according to comparison 3 was prepared using carbendazim of Embodiment 1 in place of the antimicrobial composition in Embodiment 1. Resin laminate according to comparison 4 was prepared using inorganic antimicrobial agent containing silver-supporting zirconium phosphate and zinc oxide at a ratio of 18:82 in place of the antimicrobial composition in Embodiment 1.

(Evaluation Method)

(1) Preparation of Inorganic Salt Medium

Inorganic salt base shown in Table 7 was prepared, which was subjected to autoclave sterilization. Subsequently, pH of the inorganic salt base was adjusted in a range of 6.0 to 6.5 with sodium hydroxide solution (NaOH aqueous solution).

TABLE 7

| | | | |
|---|---|---|---|
| KH₂PO₄ | 0.7 g | FeSO₄•7H₂O | 0.002 g |
| K₂HPO₄ | 0.7 g | ZnSO₄•7H₂O | 0.002 g |
| MgSO₄•7H₂O | 0.7 g | MnSO₄•7H₂O | 0.001 g |
| NH₄NO₃ | 1.0 g | Agar | 15 g |
| NaCl | 0.005 g | Deionized Water | 1000 ml |

(2) Preparation of Mixed Spore Solution

Mold spores composed of strains shown in the table 8 below (77 mixed species) were suspended in distilled water, which was filtered to prepare mixed spore solution with concentration of 1*10⁶ cell/ml. Sodium lauryl sulfate was used for dispersion in suspending the spores.

TABLE 8
Test Spores (77 Fungi): 6° C. ± 4° C., stock-culture pure
culture spores preserved within 30 days was used

```
  1. Alternaria alternata
  2. Alternaria tenuis
  3. Alternaria brassicicola
  4. Alcaligenes faecalis
  5. Aspergillus candidus
  6. Aspergillus flavus
  7. Aspergillus humigatus
  8. Aspergillus niger
  9. Aspergillus ochraceus
10. Aspergillus oryzae
11. Aspergillus restrictus
12. Aspergillus terreus
13. Aspergillus versicolor
14. Aspergillus ustus
15. Aureobasidium pullulans
16. Botrytis cinera
17. Candida albicans
18. Candida glabrata
19. Chyptococcus neoformaus
20. Chaetomium globosum
21. Cladosporium cladosporioides
22. Cladosporium sphaerospermum
23 Cladosporium herbarum
24. Cladosporium resinae
25. Curvularia lunata
26. Drechslera australiensis
27. Epicoccum purpurascens
28. Eurotium tonophilum
29. Eurotium rybrum
30. Eurotium chevalieri
31. Eurotium amsterlodami
32. Exophiale jeanselmei
33. Fusarium semitectum
34. Fusarium oxysporum
35. Fusarium solani
36. Fusarium roseum
37. Fusarium moniliforme
38. Fusarium proliferatum
39. Geotricham candidum
40. Geotricham lactus
41. Gilocladium virens
42. Monilia fructigena
43. Monilia nigral
44. Mucor racemosus
45. Mucor rouxii
46. Mucor spinesceus
47. Mucor spinecens
48. Myrothecium verrucaria
49. Nigrospora oryzae
50. Nigrospora sphaerica
51. Neurospora sitophila
52. Penicillium frequentance
53. Penicillium islandicum
54. Penicillium citrinum
55. Pullularia pullulans
56. Penicillium expansum
57. Penicillium cyclopium
58. Penicillium citreo-viride
59. Penicillium funiculosum
60. Penicillium nigricans
61. Penicillium lilacinum
62. Pestalotia adusta
63. Pestalotia neglecta
64. Phoma citricarpa
65. Phoma terrestrius
66. Phoma glomerata
67. Rhizopus nigricans
68. Rhizopus oryzae
69. Rhizopus storonifer
70. Rhizopus sorani
71. Scedosporium apiospermum
72. Trichophyton mentagrophytes
73. Trichoderma viride
74. Trichoderma koningii
75. Trichoderma harzianum
76. Ulocladium atrum
77. Wallemia sebi
```

(3) Evaluation Method

The mixed spore solution prepared in (2) was sprinkled on inorganic salt medium prepared in (1). The test pieces prepared in advance were put on the salt medium, which were subjected to temperature of 28° C. and humidity of 85% RH or more for 28 days to cultivate the molds. Growing condition of the molds was visually checked and evaluated according to determination standard shown in table 9. The results are shown in table 10.

TABLE 9

| Evaluation | Mold Growing Condition (Visual Check) |
|---|---|
| 1 | No growth on test piece |
| 2 | Growth occupied less than 10% of total surface of test piece |
| 3 | Growth occupied 10-30% of total surface of test piece |
| 4 | Growth occupied 30-60% of total surface of test piece |
| 5 | Growth occupied more than 60% of total surface of test piece |

TABLE 10

| | Embodiment 1 | | Comparison 1 | | Comparison 2 | | Comparison 3 | | Comparison 4 | |
|---|---|---|---|---|---|---|---|---|---|---|
| | PU | PVC | PU | PVC | PU | PVC | PU | PVC | PU | PVC |
| After | 1 | 1 | 4 | 3 | 3 | 2 | 2 | 2 | 3 | 3 |
| two | | | | | | | | | | |
| weeks | | | | | | | | | | |
| After | 1 | 1 | 5 | 4 | 4 | 3 | 4 | 3 | 4 | 4 |
| four | | | | | | | | | | |
| weeks | | | | | | | | | | |

(Evaluation Results)

As shown in table 10, comparisons 2 and 3 using organic antimicrobial agent exhibited slightly more antimicrobial effects than comparison 4 using inorganic antimicrobial agent and comparison 4 exhibited more antimicrobial effects than comparison 1 using no antimicrobial agent after cultivating for two weeks. However, mold growing was recognized after four-week cultivation, which showed that sufficient antifungal performance could not be exhibited solely using organic antimicrobial agent or inorganic antimicrobial agent. On the other hand, the Embodiment 1 containing the antimicrobial composition according to the present invention exhibited no mold-growing even after four-week cultivation, which clearly showed strong antifungal performance.

### Experiment 2

Respective components of aqueous unsaturated polyester resin (reactive resin for reinforced plastic such as gel coat) used for reinforced plastic as an antimicrobial molding according to the present invention were adjusted to check the antimicrobial effects thereof.

### (Sample) Embodiment 2, Comparisons 5-8

Commercially available thiabendazole (obtained from KANTO CHEMICAL CO., INC as chemical reagent) and carbendazim (obtained from KANTO CHEMICAL CO., INC as chemical reagent) as imidazole organic antimicrobial agent, silver-supporting zirconium phosphate (manufactured by TOAGOSEI CO., LTD, product name Novaron) and zinc oxide (obtained from KANTO CHEMICAL CO., INC as chemical reagent) as inorganic antimicrobial agent were blended by a ratio of 33:33:6:28 to prepare an antimicrobial composition.

The prepared antimicrobial composition was added to styrene monomer (purchased as chemical reagent) to be contained by 6% by mass, which was churned and mixed by a mixer (manufactured by PRIMIX Corporation, product name T.K. ROBOMICS) so that average particle size became 0.8 μm or smaller to prepare antimicrobial dispersion liquid. 5 g of the antimicrobial dispersion liquid was added to 93 g of base compound of curing material (manufactured by DH Material Inc., product name; polyset HK2188PT-M), which was sufficiently churned and mixed by a mixer (manufactured by PRIMIX Corporation, product name T.K. ROBOMICS) to prepare base material.

2 g of curing agent (manufactured by NOF CORPORATION product name; PERMEK N) was added to the base material, which was churned and mixed by a mixer (manufactured by PRIMIX Corporation, product name T.K. ROBOMICS). Immediately after adding the curing agent and churning, canequim 3 (cotton fabric) is soaked in the composition to absorb the composition, which was subjected to one-night (10 hours) curing reaction at 40° C. to prepare a test piece as an antimicrobial molding (example 2).

Molding according to comparison 5 was prepared without adding the antimicrobial composition in Embodiment 2. Molding according to comparison 6 was prepared using thiabendazole in Experiment 1 in place of the antimicrobial composition in Embodiment 2. Molding according to comparison 7 was prepared using carbendazim of experiment 1 in place of the antimicrobial composition in Embodiment 2. Molding according to comparison 8 was prepared using inorganic antimicrobial agent in experiment 1 in place of the antimicrobial composition in Embodiment 2.

(Evaluation Method)

The mixed spore solution prepared in (2) was sprinkled on inorganic salt medium prepared in (1). The test pieces prepared in advance were put on the salt medium and the molds were cultivated in the same manner as experiment 1. Growing condition of the molds was evaluated according to determination standard shown in table 9 in the same manner as experiment 1. The results are shown in table 11.

TABLE 11

| | | Compar- | Compar- | Compar- | Compar- |
|---|---|---|---|---|---|
| | Embodiment 2 | ison 5 | ison 6 | ison 7 | ison 8 |
| After | 1 | 5 | 2 | 2 | 3 |
| two | | | | | |
| weeks | | | | | |
| After | 1 | 5 | 4 | 4 | 5 |
| four | | | | | |
| weeks | | | | | |

(Evaluation Results)

As shown in table 11, comparisons 6 to 8 using antimicrobial agent exhibited slightly more antimicrobial effects than comparison 5 using no antimicrobial agent after cultivating for two weeks. However, fungi grew over 60% of the total area of the test piece in comparisons 5 and 8 after four-week cultivation and 30-60% of the total area of the test piece in comparisons 6 and 7, which showed that sufficient antifungal performance could not be exhibited solely using organic antimicrobial agent or inorganic antimicrobial agent. On the other hand, the Embodiment 2 containing the antimicrobial composition according to the present invention exhibited no mold-growing even after four-week cultivation, which clearly showed strong antifungal performance.

### Experiment 3

Respective components of sheet molding usable as waterproof liner such as pool liner and roofing sheet as an antimicrobial molding of the present invention were adjusted to check the antimicrobial effects thereof.

### (Sample) Embodiment 3, Comparisons 9-12

Commercially available thiabendazole (obtained from KANTO CHEMICAL CO., INC as chemical reagent) and carbendazim (obtained from KANTO CHEMICAL CO., INC as chemical reagent) as imidazole organic antimicrobial agent, silver-supporting zirconium phosphate (manufactured by TOAGOSEI CO., LTD, product name Novaron) and zinc oxide (obtained from KANTO CHEMICAL CO., INC as chemical reagent) as inorganic antimicrobial agent were blended by a ratio of 33:33:6:28 to prepare an antimicrobial composition.

The prepared antimicrobial composition was added to DIDP (plasticizer for PVC) to be contained by 0.5% by mass, which was churned and mixed by an azihomomixer (manufactured by PRIMIX Corporation, product name T.K. ROBOMICS) so that average particle size became 0.8 μm or smaller (measured by a measuring instrument Microtrac MT3300 (product name) manufactured by NIKKISO CO., LTD) to prepare antifungal dispersion plasticizer liquid.

Subsequently, polyvinyl chloride resin (PVC: polymerization degree 1000) and the antifungal dispersion plasticizer liquid were mixed at a ratio of 1:1, which was kneaded by a banbury mixer and was molded in a sheet-shape by a calendar roller to prepare a test piece (Embodiment 3).

Resin sheet according to comparison 9 was prepared without adding the antimicrobial composition in Embodiment 3. Resin sheet according to comparison 10 was prepared using thiabendazole (obtained from KANTO CHEMICAL CO., INC as chemical reagent) in place of the antimicrobial composition in Embodiment 3. Resin sheet according to comparison 11 was prepared using carbendazim (obtained from KANTO CHEMICAL CO., INC as chemical reagent) in place of the antimicrobial composition in Embodiment 3. Resin sheet according to comparison 12 was prepared using inorganic antimicrobial agent containing silver-supporting zirconium phosphate (manufactured by TOAGOSEI CO., LTD, product name Novaron) and zinc oxide (obtained from KANTO CHEMICAL CO., INC as chemical reagent) as inorganic antimicrobial agent at a ratio of 18:82 in place of the antimicrobial composition in Embodiment 3.

(Evaluation Method)

Antifungal test was conducted on the example 3 and comparisons 9-12 in the same manner as the other example and comparisons. The results are shown in table 12.

TABLE 12

| | Exam- | Comparison | Comparison | Comparison | Comparison |
|---|---|---|---|---|---|
| | ple 3 | 9 | 10 | 11 | 12 |
| After two | 1 | 4 | 3 | 3 | 4 |
| weeks | | | | | |
| After four | 1 | 5 | 4 | 4 | 5 |
| weeks | | | | | |

(Evaluation Results)

As shown in table 12, 60% or more of the test piece was covered with mold in the comparison 9 adding no antimicrobial agent. The mold also grew in an environment using a single-component organic antimicrobial agent or an inorganic antimicrobial complex agent, On the other hand, the example 3 containing complex components clearly exhibited antifungal effects, whereby synergetic effects of the antifungal components could be confirmed.

1. An antimicrobial molding, comprising: a curing material; and an antimicrobial composition,
the antimicrobial composition containing at least two organic antimicrobial agents selected from imidazole organic antimicrobial agents and an inorganic antimicrobial agent.

2. The antimicrobial molding according to claim 1, wherein
the curing material is a thermoplastic resin.

3. The antimicrobial molding according to claim 1, wherein
the curing material is a resin material solidified by two-pack mixing.

4. The antimicrobial molding according to claim 1, wherein
the curing material is a resin that is cured by irradiating one of light beam, radiation ray and electron beam.

5. The antimicrobial molding according to claim 1, wherein
an average particle size of the antimicrobial composition is controlled to be 1 μm or less.

6. The antimicrobial molding according to claim 1, wherein
the two organic antimicrobial agents selected from the imidazole organic antimicrobial agents are one having a thiazolyl group on benzimidazole ring and one having a carbamate group on benzimidazole ring.

7. The antimicrobial molding according to claim 1, wherein
the inorganic antimicrobial agent is at least one of silver-based antimicrobial agent and zinc oxide.

8. The antimicrobial molding according to claim 1, wherein
the antimicrobial molding is foam-molded.

9. A laminated body, comprising a sheet layer formed by molding the antimicrobial molding according to claim 1 into a sheet-shape.

10. A heat insulator, comprising a foam-molded body of the antimicrobial molding according to claim 1.

11. A synthetic leather article, comprising: the laminated body according to claim 9, the laminated body comprising synthetic leather.

12. A synthetic leather article, comprising: the laminated body according to claim 9, the laminated body comprising an artificial leather.
